(19) United States
(12) Patent Application Publication
(10) Pub. No.: US 2026/0328565 A1
(43) Pub. Date: Oct. 22, 2026

(54) METHOD FOR IDENTIFYING ANOMALIES AND THUS ALSO ACTUAL MACHINING POSITIONS OF A WEB AND FOR CLASSIFYING SAID ANOMALIES, SYSTEM, AND COMPUTER PROGRAMME PRODUCT

(71) Applicant: BHS Corrugated Maschinen- und Anlagenbau GmbH, Weiherhammer (DE)

(72) Inventors: Madeleine Löhnert, Allersberg (DE); Thomas Münster, Vilseck (DE); Stefan Trenz, Neuhaus (DE)

(21) Appl. No.: 19/123,003

(22) PCT Filed: Oct. 23, 2023
(86) PCT No.: PCT/EP2023/079401

§ 371 Date: Apr. 21, 2025

(30) Foreign Application Priority Data
Oct. 25, 2022 (DE) 102022211293.8

(51) Int. Cl. G01B 21/20; B31B 50/00; G06N 3/048

(52) U.S. Cl. CPC G01B 21/20; B31B 50/006; G06N 3/048

(57) ABSTRACT

The invention relates to a method, wherein: a web (4) is provided in which a number of machining operations (8, 10) have been made by means of a cutting/grooving unit (6), in each case on the basis of a predefined machining position (24) and a predefined cut type or groove type; a height profile (14, 16) of the web (4) is measured using a sensor unit (12) on at least one side of the web (4) and transversely to a conveying direction (F) of the web (4); a number of anomalies (20) and thus also actual machining positions (18) are identified in the height profile (14, 16) by identifying as an anomaly (20) each section of the height profile (14, 16) where the height profile (14, 16) reaches a predefined threshold value (26); and each anomaly (20) is classified by assigning same to the cut type or groove type said anomaly (20) most closely resembles. The invention also relates to a system (2) and to a computer program product.

The invention relates to a method for identifying anomalies, in particular cuts and/or grooves, and thus also actual machining positions of a web, in particular a corrugated cardboard web, and for classifying said anomalies. The invention further relates to a system and a computer program product.

The web is, for example, a corrugated cardboard web composed of several layers of paper. The system is, for example, a corrugated cardboard installation, with which the web is first produced and then further machined. The web is regularly machined such that a number of cuts and/or grooves are made therein using a cutting and grooving unit in order, on the one hand, to divide the web into several separate panels and then sheets by means of suitable cuts and, on the other hand, to provide the sheets with a number of creasing, folding, separating edges or the like by means of suitable grooves, so that the respective sheet can then be converted from an originally flat form into a typically three-dimensional final form (e.g. a box or a carton).

For the most economical and ecological production of a corrugated cardboard web as well as panels and sheets made therefrom, it is desirable to produce as little scrap as possible during production and machining. Scrap regularly occurs when cuts and/or grooves are introduced incorrectly or not at all. The earlier and more reliably any defects are detected during the introduction of cuts and/or grooves, the less scrap is produced and the more targeted the response can be, e.g. replacing a tool or adjusting an operating parameter.

DE 10 2015 200 397 A1 describes a testing device for testing the quality of machining results of a machining device for substrate sheets, comprising: a light source for illuminating a machining portion of a substrate sheet that is mechanically machined by the machining device by means of a machining tool in a structure-changing manner, an image sensor that is configured to capture an image of the illuminated machining portion and, on this basis, to generate actual image data of the machining portion. Furthermore, an evaluation device is provided which is configured to output an evaluation result regarding the quality of the machining results, wherein target data for the machined machining portion are stored in the evaluation device and the evaluation device is configured to compare the actual image data of the machining portion with the target data under prespecified evaluation criteria and to determine correction data for the machining parameters as part of the evaluation result on the basis of a resulting comparison result.

DE 10 2019 105 217 A1 describes a folding machine for folding box blanks comprising at least one control device, means for conveying the folding box blanks from an input to an output of the folding machine, a device for folding the folding box blanks and an alignment unit for folded folding box blanks. The folding machine has a device for optically detecting grooves and/or gaps in the folding box blanks and a device for optically detecting grooves in the transport direction is arranged upstream of the means for folding the folding box blanks and/or a device for optically detecting gaps is arranged downstream of the means for folding the folding box blanks and upstream of the alignment unit in the transport direction.

U.S. Pat. No. 5,581,353 A describes a device for measuring at least two properties of corrugated cardboard, the device comprising: at least one pair of laser triangulation sensors, wherein one of the sensors is arranged on one side of the corrugated cardboard and the second sensor on an opposite side. The distance between the respective sensor and the surface of the corrugated cardboard is measured and converted into at least two properties of the corrugated cardboard.

Against this background, it is an object of the invention to improve the checking of the machining of a web by a cutting/grooving unit. For this purpose, an appropriate method, a system and a computer program product are to be specified.

The object is achieved according to the invention by a method having the features according to claim 1, a system having the features according to claim 16, and a computer program product having the features according to claim 17. Advantageous embodiments, further developments, and variants are the subject of the dependent claims. The statements made in connection with the method also apply, mutatis mutandis, to the system and to the computer program product, and vice versa. Advantageous embodiments of the system result from the fact that it is designed to carry out at least parts of the method or one or more steps of the method. For this purpose, the system has a suitably designed control unit. Analogously, advantageous embodiments for the computer program product result from it comprising commands which, when executed by a computer, cause the computer to carry out at least parts of the method or one or more steps of the method.

The method is in particular a method for identifying anomalies and thus also actual machining positions of a web and for classifying said anomalies. The method makes possible, in particular, an improved checking of machining operations of a cutting/grooving unit and, in particular, also an improved checking of machining positions of these machining operations, i.e. of cutting and/or grooving positions. First, a web is provided in which a number of machining operations have been made by means of a cutting/grooving unit, in each case on the basis of a predefined machining position and a predefined cut type or groove type (generally “machining type”). Here and in general, “a number of” is understood to mean “one or more” or “at least one.” The machining operations are mechanical operations on the web and involve either a cut or a groove in the web. Each cut was made according to a predefined cut type and each groove according to a predefined groove type. The cutting/grooving unit is hence used to introduce cuts and/or grooves into the web. A cut represents a separation point at which the web is severed. In contrast, a groove initially represents only an embossing point, in particular a desired bending point (or the like) in the web, which allows a finished panel or sheet to be folded along said bending point. Accordingly, cuts and grooves differ in particular in that the web is completely severed in the case of a cut, which is not the case or only partially the case with a groove. The cuts and/or grooves are used in particular for cutting the web into single panels or sheets and/or for forming breaking, folding or creasing edges of the panels or the later sheets, e.g. to form each of these into a box, carton or the like.

A cutting/grooving unit is understood to mean in particular a cutting and/or grooving unit, i.e. a unit that is designed either for cutting the web or for grooving the web, or both. In the following, without limiting the generality, a cutting and grooving unit is assumed, with which the web is both cut and grooved. The cutting/grooving unit is in particular part of a system for processing the web. Preferably, the system is a corrugated cardboard installation for producing corrugated cardboard, specifically sheets of corrugated cardboard. The web is made in particular of paper and is preferably a corrugated cardboard web composed of several layers of paper. Preferably, the cutting/grooving unit is part of the corrugated cardboard installation and the web is a corrugated cardboard web which is produced and processed by the corrugated cardboard installation. In a suitable embodiment, the cutting/grooving unit is provided downstream of a so-called “double facer” of the system. In the double facer, a plurality of intermediate products for a corrugated cardboard web are assembled to form the actual corrugated cardboard web. In particular, the double facer also marks the end of a so-called “wet end” of the system (and is also part thereof), followed by a so-called “dry end”, with which the corrugated cardboard web is converted in particular into individual panels and then into individual sheets. In particular, the cutting/grooving unit is part of the dry end of the installation. Hereinafter, it is assumed, without restriction of generality, that the web is a corrugated cardboard web. Although such an embodiment is preferred, the statements made herein apply in principle to any web, in particular made of paper, possibly even with only one layer, and also to any system which processes a web.

The web is machined by means of the cutting/grooving unit at a number of actual machining positions (i.e. cutting and/or grooving positions). Due to the principles involved, as a result of the machining operation an in particular characteristic anomaly is formed at each actual machining position. By identifying the anomalies (as explained in detail below), the actual machining positions are thus automatically identified, i.e. detected, which are then also referred to as detected machining positions. The machining positions are predefined in particular by order data for an order for the system for machining the web. Accordingly, the order data then contain a number of predefined machining positions. The cut type or groove type to be carried out at each predefined machining position is also predefined in the order data, so that a predefined cut type or groove type is also assigned to each predefined machining position in the order data. The cutting/grooving unit is controlled according to the order data. However, due to errors or inaccuracies, the cutting/grooving unit does not necessarily produce the machining operations at the predefined machining positions but at the actual machining positions, and the required cut or groove type may not be reproduced exactly, or even an incorrect cut or groove type may be used. In other words, the cuts and grooves that are actually created are not necessarily located exactly at the predefined machining positions, and the execution of a cut or groove can also be faulty, so that an incorrect cut type or groove type is created at a machining position. It is therefore advantageous to check the result of the machining operation. Furthermore, an anomaly is not necessarily caused by machining with the cutting/grooving unit but can also be caused by other machining operations or by damage. These anomalies and a corresponding actual machining position are also detected, but the latter is not assigned to a predefined machining position, nor does the anomaly necessarily correspond to a known cut or groove type. For this reason, it is advantageous for checking to be designed such that such anomalies are not falsely identified as predefined machining operations. Advantageously, the anomalies are evaluated and characterized independently of each other, i.e. classified as a whole, so that false conclusions (e.g. based on the assumption that from the outset all anomalies are cuts or grooves) are avoided as far as possible.

In the method described herein, a height profile of the web is measured by using a sensor unit on at least one side of the web, preferably on both sides of the web, and transversely to a conveying direction (i.e. also to a longitudinal direction) of the web. The sensor unit is preferably part of the system. Preferably, the height profile is measured in-line in the system and downstream of the cutting/grooving unit. The web has a width perpendicular to the conveying direction and the height profile preferably extends over the entire width. The height profile is also referred to as the transverse profile because it is generally measured transversely and preferably—but not necessarily-perpendicular to the conveying direction. The height profile is also called the surface contour because it reproduces the contour of a surface of the web. As described, basically during machining there may be deviations between the specifications in the order data. Machining with the cutting/grooving unit produces characteristic changes in the height profile of the web, which allows the actual machining positions and the machining performed there to be identified and verified by measuring and evaluating the height profile. The height profile is measured, for example, with a distance sensor and then indicates the distance between the web and the sensor as a function along a transverse direction transverse to the conveying direction. The height profile can be represented in particular as a vector with a plurality of measured values, each at a different position in the transverse direction. A respective measured value and a respective position (i.e. position value) together form a data point, and the length of the vector corresponds to the number of data points.

In the height profile, machining by the cutting/grooving unit can be identified as an anomaly at actual machining positions, i.e. as deviations, for example, from a normal state of the web, i.e. of a web without any machining operations. For this reason, a number of anomalies and thus also actual machining positions are now identified in the height profile by identification of those sections of the height profile as an anomaly in which the height profile reaches, in particular exceeds or falls below, a predefined (first) threshold value. Each anomaly is therefore a section of the height profile and thus two-dimensional, i.e. it contains several data points (measured values and position values). Each anomaly corresponds to an actual machining position, which contains the positions of the corresponding section, i.e. only the position values of a respective anomaly, and is therefore one-dimensional and, so to speak, a position interval or position range. When a threshold value is used, a definition of the normal state will be redundant; it is rather the case that the threshold value indicates what is considered normal/non-normal. A respective section is in particular a connected set of data points. A respective section is advantageously not only the region in which the height profile actually reaches the threshold value but contains a certain addition, particularly to both sides. The addition is advantageously dimensioned such that the anomaly, which regularly begins along the height profile before the threshold value is reached, is captured as completely as possible by the section.

Each anomaly is classified by means of a classification by assigning the anomaly to the cut type and/or groove type which the anomaly most closely resembles. It is therefore not only checked whether or to what extent a particular machining operation corresponds to the cut or groove type according to the order data but it is also checked which cut or groove type is actually present. The check is initially independent of the order data. The classification differs from a simple target/actual comparison in particular in that the anomaly is not only compared with a single cut or groove type but also with several different ones. In addition, in this case, in particular by use of the threshold value, anomalies are actively searched for in the entire height profile rather than by checking the height profile at the predefined machining positions, so that non-predefined machining operations (e.g. damage) are also found and also advantageously classified. Overall, the checking of the machining of the web is improved and, in particular, a more detailed quality control is possible than with a simple target/actual comparison and checking of machining positions of the cuts and grooves in only predefined sections. Advantageously, this makes it possible to detect any incorrect cuts and grooves that occur outside the expected sections.

The classification described herein is also more reliable compared to a simple minimum or maximum function for identification, which inherently leads to a cut or groove always being detected, even if nothing of the sort has occurred. In addition, a validation is possible in this case, which advantageously detects whether the correct groove profile (i.e. the correct grooving body) was used for a particular grooving operation in accordance with the order data. Finally, the method described herein also makes it possible to check the web for damage away from the cuts and grooves. Overall, the method described herein makes it possible to detect missing or incorrectly positioned cuts and grooves, to detect incorrectly inserted cutting and grooving bodies, to detect inadequately executed cuts and grooves, and to detect damage to the web. In response to this, a corresponding message is advantageously issued and/or an operator of the system is informed accordingly. Optionally, the system (and thus the further machining of the web) is stopped or at least slowed down, thus preventing the production of scrap.

The method carried out and described herein, especially the classification, is also in contrast to DE 10 2015 200 397 A1, DE 10 2019 105 217 A1 and U.S. Pat. No. 5,581,353 A mentioned above. During classification, a cut or groove type is specifically assigned to a signal section of the height profile. This means that the actual cut or groove produced is not only identified as such, but also by type. In addition, the entire web in particular is checked, or at least extensive sections thereof, and not just those individual positions where cuts or grooves are expected.

For cutting and/or grooving, the cutting/grooving unit has in particular one or more corresponding cutting bodies and/or grooving bodies, i.e. preferably several cutting bodies and/or several grooving bodies, thus not merely a combination of a single cutting body and a single grooving body. The web is mechanically machined in either case; in the case of cutting, it is merely separated, and in the case of grooving, it is shaped. A cutting body typically has a first blade which, during operation, rotates about an axis transverse to the web and is then inserted into the web to produce a cut. The cutting body further has a counter-roller, which is arranged on the opposite side of the web and interacts with the first blade (in principle, a second blade instead of the counter-roller is also conceivable). Similarly, a grooving body regularly has a first roller with a first profiled running surface which, during operation, rotates about an axis transverse to the web and is then pressed against the web to produce a groove. The grooving body further has a counter-roller, regularly with a second profiled running surface, which is arranged on the opposite side of the web and interacts with the first profiled running surface. The first and second running surfaces do not necessarily have the same profile. Different pairings of running surfaces are suitable for creating different grooves, for example, a so-called one-point groove, three-point groove, five-point groove, point-point groove or asymmetric groove. A particularly common groove is a three-point groove using a three-point grooving body. By displacing the running surfaces of a grooving body in the transverse direction relative to each other a so-called offset groove is also possible. This displacement is referred to as an offset. Such offset grooves can also be detected and checked using the method described herein. A further offset is regularly possible even perpendicular not only to the transverse direction but also to the conveying direction. This sets a distance between the two running surfaces of a grooving body, the so-called grooving body distance. This is conveniently done in dependence on the thickness of the web. The grooving body distance can also be detected and checked using the method described herein.

Advantageous aspects and preferred embodiments of the method are described in detail below. First, an overview is given and then the following aspects are discussed in more detail: measurement, pre-processing, position detection, validation of the machining positions, classification, validation of the classification result.

### Overview

As already described, in the method at least one height profile of the web is measured as part of a measurement and then evaluated by determining anomalies therein (i.e. conspicuous sections of the height profile). For the evaluation, the height profile is first processed and, if necessary, filtered in the course of a pre-processing which in particular uses methods of digital signal processing.

The anomalies and thus also the detected machining positions, i.e. the actual machining positions, are then identified in the height profile by means of position detection, which in particular applies suitable statistical methods. Position detection takes place in particular during ongoing operation of the system in order to ensure smooth machining of the web. The detected machining positions are then advantageously assigned to the predefined machining positions from the order data.

For a further analysis, the method described herein uses the already mentioned classification operation, by means of which the height profile is classified portion by portion at the detected machining positions with regard to the machining operations carried out (cuts and grooves), in particular with regard to any damage, deviations, production errors, etc., i.e. the anomalies are classified. For the actual classification, i.e. assignment of an anomaly to a specific cut or groove type (preferably also to a damage type, deviation type, production error type, etc.), various embodiments are suitable, some of which are described below.

In addition, a validation is also advantageously carried out. Validation means a validation of the machining positions or a validation of the classification result, preferably both, so that validation is then two-part, which is assumed below without restriction of generality. When validating the machining positions, a message is in particular issued, the system is stopped or another suitable measure is initiated as soon as it is determined (e.g. already during position detection) that the detected machining positions do not correspond within a given tolerance with the predefined machining positions from the order data or are directly identified as damage, deviations, production errors or the like. Validation of the classification result on the basis of the order data is carried out analogously to the validation of the machining positions, i.e. it is checked whether the correct cut or groove type was applied and/or was carried out correctly, in particular whether the cuts and grooves were made with the correct cutting or grooving body. As soon as it is determined during this validation that the detected machining operations do not match the predefined cut and/or groove types from the order data within a given tolerance, a corresponding message is issued, the system is stopped or another suitable measure is initiated. Overall, in any embodiment, the validation checks and ensures a certain quality of the machining positions and machining operations carried out there and, if necessary, initiates an appropriate response.

The method is preferably realized by several modules which are in particular functionally separated from one another. A first module is preferably a data pre-processing module, which carries out the pre-processing and accordingly provides the measured height profile as a uniform database for the subsequent modules. A second module is preferably a detection module, which carries out position detection and accordingly detects the anomalies in the height profile, then allocates them to detected (or actual) machining positions and finally outputs them, preferably to a third module, which is an assignment module. The assignment module carries out the assignment of the machining positions and accordingly assigns the detected machining positions to the predefined machining positions according to the order data. A fourth module is preferably a classification module which carries out the classification operation and assigns a cut or groove type to each anomaly, or optionally even a damage type, deviation type, production error type or the like. A fifth module is preferably a validation module which carries out the validation operation and compares the detected machining positions with the predefined machining positions and/or compares the detected cut and/or groove types with the predefined cut and/or groove types. Optionally, one or more of the modules are present multiple times, in particular in order to evaluate cuts and grooves separately, in particular to classify and/or validate them.

The various modules are suitably combined with one another in a control unit (integrated embodiment); alternatively, one or more modules are accommodated separately in one or more other control units (distributed embodiment). One or more of the control units mentioned and thus also the modules they may accommodate are advantageously part of the system described herein.

### Measurement

The height profile is suitably measured by using a sensor unit (also referred to as sensor module) having a number of sensors. A suitable sensor is in particular a distance sensor as already mentioned above, e.g. a laser triangulation sensor, which can be offset transversely to the web (e.g. by means of a linear motor) and measures a distance in the direction of the web, i.e. the distance between the sensor and the web. A camera is also suitable as a sensor, with which in particular an image of the web is taken, from which the height profile is then obtained. The sensor outputs a measured value (distance) for each measuring position across the web, which measured value varies depending on the nature of the web surface. As a result, the sensor thus outputs a height profile that contains a series of measured values, in particular in the form of a vector. Each measured value is also assigned a position (measurement position) along the web, which is determined, for example, from the travel path of the sensor. A pair consisting of a measured value and the corresponding position is a data point. The sensor unit is preferably arranged immediately downstream of the cutting/grooving unit, i.e. the web run from the cutting/grooving unit to the sensor unit is at most 10 m, preferably at most 1 m. The sensor unit advantageously has a pressure roller in order to press the web against a support as it passes through the sensor unit and when measuring the height profile and to suppress any curvature of the web as far as possible, at least during the measurement.

The sensor unit preferably comprises two sensors as described, one of which measures an upper height profile along a top side of the web and another of which measures a lower height profile along a bottom side of the web. This advantageously takes into account detailed information that is only found in one of the two height profiles. In particular, both height profiles are processed in the same way, so that for the sake of simplicity reference will be made below to only one height profile. In principle, it is sufficient to use only one height profile (i.e. on the top side or on the bottom side), but the use of both height profiles is preferred, especially when classifying grooves, since the height profiles on the top side and bottom side regularly differ and thus make possible a more precise detection of the groove type and thus a more precise classification. In addition, cuts and grooves can then be distinguished more clearly from one another. However, the processing steps for both height profiles are conveniently identical.

In principle, the data points obtained from the measurement can be used directly for the subsequent steps and modules, but it is advantageous if the data points are pre-processed, i.e. the measured height profile is pre-processed and is then a pre-processed height profile.

Pre-Processing with the Data Pre-Processing Module

During pre-processing, the measured height profile is processed in a suitable manner, especially for subsequent position detection. For example, it is possible that the measuring range is exceeded when measuring the height profile and no distance can be measured, which is regularly the case with a cut because the web is interrupted at the cut's machining position. Accordingly, if the measuring range is exceeded, it may not be possible to generate a valid measured value; instead, a NaN (not a number) is returned as the measured value and a corresponding gap is found at the corresponding measuring position in the height profile. During pre-processing, such gaps (NaNs) in the height profile are now advantageously removed in order to obtain a gap-free height profile. However, the gaps are not simply omitted but are replaced by suitable values, e.g. by means of linear interpolation based on the measured values of adjacent measuring positions. Alternatively, a gap is simply replaced by a previously defined value, e.g. with a sample-and-hold element by the last valid measured value. Alternatively, a value of “0” is used for each gap (i.e. a vanishing distance). In any case, the number of data points should be retained as far as possible. However, the options mentioned may have significant effects in the frequency range, so that it is advisable to additionally filter the height profile processed in this way with an anti-aliasing filter.

Furthermore, the data pre-processing module is used to conveniently cut the measured height profile to the width of the web, i.e. the zero point of the height profile is displaced to a side edge of the web. Alternatively or additionally, the height profile is limited to the width of the web, which facilitates a later comparison of the detected machining positions with the predefined machining positions.

It is advisable to map the height profile onto an in particular equidistant grid using the data pre-processing module. New data points with new (measured) values and positions are generated from the measured values and measuring positions which are distributed along an equidistant grid. In this way, the distance between the data points of the height profile is determined. The height profile is then in particular a vector in which each individual component corresponds to a value for a position along the height profile. If necessary, further data points are derived (e.g. interpolated) on the basis of the measured values in order to obtain a specific grid and in particular a specific data point density (e.g. number of data points per millimeter). The data point density is relevant in particular for the accuracy of viewing and processing the height profile in the frequency domain. Investigations have shown that a data point density of no more than 10/mm is still sufficient; with an equidistant grid, this corresponds to a distance of 0.1 mm between the individual positions of the height profile. The data point density is preferably predefined and, based on this, support points are defined as new positions at equidistant intervals, at which a new value for a new data point is then determined on the basis of the measured values and measuring positions, e.g. if a measuring position and a support point match, then this measuring position with the associated measured value is used as a data point; otherwise the data point is interpolated from the next measured values and measuring positions. The resulting height profile is also referred to as the adjusted height profile.

The height profile is suitably calibrated in order to eliminate deviations in the parallelism of the two sensors due to manufacturing tolerances or temperature fluctuations. For this purpose, a calibration vector is determined, for example by means of a calibration measurement, and is then subtracted from the height profile. However, the specific embodiment of such a calibration is of secondary importance in this case and is therefore not described in detail.

The processed, cropped, adjusted and/or calibrated height profile is then output as a pre-processed height profile for the subsequent steps and modules.

### Filters

The detection module is designed to identify any anomalies (connected subsets of data points) in the processed height profile and thereby detect the actual machining positions (connected subsets of positions). First, it is assumed that the height profile of a web without any cuts and grooves, i.e. in the normal state of the web, can be described at least to a good approximation as a constant function, so that, on this basis, an anomaly is then conveniently defined as any deviation of the height profile from this constant function. In the present case, it was recognized that the anomalies are also detectable in the frequency domain, specifically in the spectrogram of the height profile. The spectrogram is a two-dimensional spectral representation and contains the frequency-dependent amplitude of the height profile as a function of the position of the respective data point (in particular along the grid). The spectrogram is generated from the height profile, for example, by means of a short-time Fourier transform (STFT), wherein the time dimension is replaced by the position (i.e. a spatial dimension), so that the frequencies are then inverse positions. The achievable frequency range depends on the data point density described above (Nyquist-Shannon sampling theorem). With ten data points per millimeter, a frequency range of 0 to 5 mm⁻¹ can be represented.

Investigations have shown that continuous lines (parallel to the frequency axis) appear in the spectrogram at exactly the same positions as actually made cuts. This means that a cut can be identified across the entire frequency spectrum and that by filtering out a suitable sub-range from the frequency spectrum (i.e. by selecting a specific frequency range) in which only the frequencies of a cut are contained, the influence of this cut on the measured height profile can be represented in isolation and thus makes possible an improved identification of the cut. Accordingly, in an advantageous embodiment, for better identification especially of cuts, a corresponding frequency range is released with the aid of a bandpass filter. The bandpass filter then has a passband that corresponds to the frequency range. A suitable frequency range is, for example, from 1.5 mm⁻¹ up to, in particular, 5 mm⁻¹, since in such a frequency range only the effect of the cuts is visible in the spectrogram and all other influences on the height profile lie completely or at least predominantly below this frequency range. Accordingly, the upper limit is not necessarily important; rather, it is defined in particular by the data point density. Similarly, at the machining positions of grooves in the spectrogram, anomalies in the frequency range from 0 mm⁻¹ up to about 0.1 mm⁻¹ are recognizable, so that in an advantageous embodiment a corresponding frequency range is released with the aid of a bandpass filter specifically for better identification of grooves. A suitable frequency range (i.e. passband of the bandpass filter) is, for example, from a frequency >0 mm⁻¹ (e.g. 0.001 mm⁻¹), for suppressing the DC component in the height profile at 0 mm⁻¹, up to 0.1 mm⁻¹. It is also useful to combine both of the bandpass filters mentioned. Depending on the application, frequency ranges other than those mentioned above may also be advantageous.

In general, in order to better identify one or more anomalies, a frequency range containing the anomalies is advantageously selected with the aid of a bandpass filter. Accordingly, in a suitable embodiment, the height profile is filtered with a bandpass filter before the anomalies are identified therein, wherein the bandpass filter releases a frequency range which is selected such that those parts of the height profile which are generated either by cuts or by grooves are specifically preserved. The released frequency range (i.e. passband) is realized by an appropriately selected bandwidth of the bandpass filter with suitable cutoff frequencies. The released frequency range is suitably selected, depending on the application, possibly differently than described above, and thus also represents an adjustable parameter of the detection module, by the adjustment of which the identification of anomalies can be optimized.

In an advantageous embodiment, pre-processing is further improved by one or more additional sensors for measuring vibrations on the web. A corresponding sensor measures a vibration of the web as it moves through the system. Furthermore, a vibration frequency of the vibration is determined and this vibration frequency is then advantageously filtered out of the height profile, e.g. by means of a corresponding frequency filter or by selecting the passband of the mentioned bandpass filter such that the vibration frequency is suppressed by the bandpass filter.

The filtering described above with one or more bandpass filters is optionally carried out within the detection module and then as part of position detection.

Position Detection with the Detection Module

The (first) threshold value is suitably determined with the aid of a statistical method and, in a preferred embodiment, is a standard deviation of the height profile, e.g. 2σ. The threshold value depends in particular on the position and forms, as it were, an envelope around the height profile. If the height profile breaks through said envelope, i.e. reaches the threshold value, this means that there is an anomaly at this position, which is also identified as such. By multiplying the standard deviation by a factor, the threshold value can be scaled as required and this factor thus represents a parameter for optimization. The threshold value and specifically its determination benefit particularly from the above-described filtering of the height profile with the aid of a bandpass filter, as this limits the height profile to the anomaly sought (cut or groove) and facilitates its identification using statistical methods. The positions of the identified anomalies of the height profile are considered as candidates for detected machining positions, in particular to be subsequently assigned to a predefined machining position by using the assignment module.

To detect cuts, anomalies are conveniently identified separately in both height profiles (upper and lower height profiles) and an anomaly is identified as a cut at an (actual) machining position if an anomaly has been identified at this machining position in both the upper and lower height profiles. Alternatively or additionally, an anomaly at an (actual) machining position is advantageously detected as a cut if there is a gap (NaN) in the upper or lower height profile at this machining position. This also includes the case in which there is a gap in both height profiles at the same time. These three criteria are suitably linked (offset) so that the presence of one of the criteria is sufficient to detect a cut.

In order to detect anomalies, specifically grooves, a differential height profile is advantageously calculated from the lower and upper height profiles, e.g. by subtracting one from the other. In other words, the height profile in which a number of anomalies are identified by identifying such sections of the height profile as an anomaly in which the height profile reaches a predefined threshold value is a differential height profile. It is assumed that an anomaly, specifically a groove, reduces the strength of the web at an (actual) machining position. The differential height profile is then conveniently filtered with a bandpass filter as described above in connection with pre-processing and is therefore particularly robust with regard to interference during the measurement. If the differential height profile reaches the (first) threshold value at a machining position, an anomaly, specifically a groove, will be detected at this machining position.

By means of the two aforementioned steps for detecting cuts, on the one hand, and for detecting grooves, on the other hand, the identified anomalies are conveniently divided into two groups even before classification, namely into a first group containing all anomalies that have been generally detected as cuts, and into a second group that analogously contains all anomalies that have been detected as grooves. The anomalies are thus pre-sorted, so to speak. These two groups of anomalies are then processed separately, i.e. classified and/or validated. In principle, the same classification module can be used for both groups or a separate, specialized classification module is used for each group.

Assignment of Machining Positions with the Assignment Module

As already mentioned above, each anomaly is assigned an actual machining position, which is automatically detected by identification of the anomaly and is then also referred to as a detected machining position. During assignment of the machining positions, the actual machining positions are assigned to the predefined machining positions and are conveniently compared for this purpose. In a suitable embodiment, the assignment module generates a correlation table which contains the resemblance of each actual machining position to each predefined machining position. For example, the correlation table is a simple distance table that contains the distances of each actual machining position from each predefined machining position. The respective actual machining position is then assigned the predefined machining position which most closely resembles the actual machining position, i.e. has the greatest resemblance to the actual machining position, e.g. has the smallest distance from the actual machining position. Advantageously, double assignment is also prevented, i.e. an assignment of several actual machining positions to only one predefined machining position, or vice versa; instead, each actual machining position is assigned at most one predefined machining position, and vice versa.

By means of the comparison described, any superfluous machining positions are also advantageously detected, i.e. those machining positions which were detected but cannot be assigned to a predefined machining position in the order data. This is the case, in particular, if the number of predefined machining positions is lower than the number of detected machining positions. Conversely, missing predefined machining positions are advantageously detected in the same manner if the number of predefined machining positions is greater than the number of detected machining positions. In this way, since not all detected/predefined machining positions can be assigned, superfluous or missing machining positions are also detected.

Also advantageous is an embodiment in which a limit value for resemblance is defined, which must at least be reached in order to carry out an assignment. If the distance is used as a measure of resemblance, the limit value is accordingly a maximum distance (e.g. 5 mm). In this way, forced assignment is prevented and the detection of superfluous and missing machining positions is improved.

In an expedient embodiment, during validation, an anomaly will be marked as an expected anomaly if a detected machining position could be assigned to a predefined machining position; otherwise, the anomaly is marked as an unexpected anomaly. Especially in the latter case, a message is conveniently issued that unexpected machining operations, damage, cuts and/or grooves have been detected. Conversely, during validation, a predefined machining position will be advantageously marked as a found machining position if a predefined machining position could be assigned to a detected machining position; otherwise, the machining position is marked as not found. During validation, this is advantageously applied analogously to the cut or groove type, so that a predefined cut or groove type will be marked as not found if it was not found by means of classification.

Classification (Characterization) with the Classification Module

The detected machining positions, which were optionally assigned to predefined machining positions as described and preferably also validated, are now classified with the classification module and thus each assigned to one of several cut types or groove types. During classification, roughly speaking, a respective anomaly is evaluated in particular with regard to its shape and/or severity, and is then, based thereon, assigned to a cut or groove type. Classification is an important part for quality assurance of the finished web (e.g. panels or sheets of corrugated cardboard) and, in particular, also makes an advantageous order traceability possible. For example, in the event of a complaint, the predefined cut and/or groove types from the order data are compared with the classified anomalies, thereby identifying a possible reason for the complaint. The same applies analogously to the detected and predefined machining positions. Advantageously, the classification described herein makes it possible to compare and check, i.e. validate, the actual production result against the order data.

Since typically several different cutting and/or grooving bodies are used, accordingly different cuts and/or grooves and thus also different anomalies in the web are generated. Each cutting body and each grooving body has its own characteristic, which leads to a corresponding characteristic (shape and/or severity) of the anomaly created. This characteristic in particular is the subject of the classification described herein. A cut usually has a much simpler characteristic compared to a groove. Since a cut is essentially a severance of the web at a specific machining position, it is initially sufficient to simply search for such a severance (e.g. by means of gaps in the measured values). Validation with the order data is therefore generally possible for cuts even without any classification. Advantageously, it is also possible to distinguish between cuts and grooves without classification. Accordingly, in an advantageous embodiment, cuts are first distinguished from grooves as described, e.g. with the aid of gaps in the height profile, and subsequently only those anomalies are classified at whose machining positions grooves were detected.

The following focuses primarily on the classification of grooves. However, the same applies to cuts, as for cuts it is generally also advantageous to consider the entire characteristic of a particular anomaly in order to draw conclusions, e.g. whether a specific cut was carried out correctly or to check whether the cutting body used is still functioning properly or needs to be replaced.

In addition to the cut and groove types, it is also advantageous to define other types that will be detected during classification. It is particularly advantageous to define a zero type which describes a portion of the web with neither cuts nor grooves. This zero type makes it particularly easy to detect when no machining operation has taken place at a predefined machining position, i.e. when a groove or cut is missing there. In particular, during the validation of the machining positions, it is then determined in the height profile where a machining operation is predefined according to the order data but no anomaly was detected, whether the zero type is present at this position. Alternatively or additionally, the anomalies at any superfluous machining positions are classified by comparison with other types and then identified, for example, as damage. The definition of other types for classification, specifically of the zero type, is carried out in a similar way to the options for defining cut and groove types described below, i.e. for example, by means of modeling, measurement or machine learning.

In a suitable embodiment, a respective anomaly is compared for classification purposes with a representative of a respective cut or groove type and the resemblance (i.e. agreement) of the anomaly and the cut or groove type is calculated by means of a distance standard. The respective representative, like the anomaly, is a series of data points, in particular a vector with the same length as the anomaly, and represents a typical or ideal shape of the corresponding cut or groove type. In other words, the representative, like the anomaly, is a set of data points (values as a function of the position). In the process, a difference is formed from the data points of the anomaly and the representative at a respective position (i.e. component by component in case of a vector) and these differences are then summed. For example, the difference is calculated according to \vec{d}=\vec{a}−\vec{v} and thus the resemblance according to

$${‖ \vec{d} ‖}_{2} = \sqrt{{\sum }_{n = - N}^{N} {( {d}_{n} )}^{2}} ,$$

wherein \vec{a} and \vec{v} are respectively the anomaly and the representative, each having 2·N+1 data points (more precisely: values).

In a likewise suitable embodiment, the representative is not merely a one-dimensional vector as described, but has one or more further dimensions in addition to the position, in particular the grooving body distance. Such a representative is then basically a set of several one-dimensional representatives, which is parametrized by one or more parameters such as the grooving body distance. The statements regarding the one-dimensional representative apply analogously to the comparison with the anomaly.

The existence of representatives is of primary importance for the classifications described below using modeling and based on measured values. For classification by means of a learning machine, appropriate information is incorporated through training of the learning machine, which training can in principle also be carried out using representatives, as described.

Classification with Modeling

In a first embodiment for classification, the representatives are determined by means of a physical model that simulates the generation of grooves (and/or cuts) on the basis of a geometry of a respective grooving body (or cutting body) of the cutting/grooving unit. First, a reference model is created for each groove type on the basis of the associated grooving body, which reference model contains all relevant properties of the corresponding groove. The reference model then serves as a representative for the classification using the classification module. Each anomaly is then compared with different representatives and classified as the groove type whose representative most closely resembles the anomaly. In a suitable embodiment, the representative is generated from design data of the grooving body, e.g. by directly using its contour in the transverse direction as a representative. However, since the grooving body typically does not transfer its contour identically but only approximately to the web, it is expedient to take a corresponding transfer function into account when defining the representative or to determine the representative on the basis of the design data or the contour of the grooving body by means of a finite element method, which then takes into account additional parameters relating to the process of creating a groove with the grooving body.

In an advantageous embodiment, the modeling, i.e. the generation of representatives, is carried out with a learning machine. This will be described in more detail below.

### Classification Based on Measured Values

In a second embodiment for classification, the representative of a respective groove type (or cut type) is determined on the basis of previous measured values, conveniently by recording a plurality of height profiles for a respective groove type (or cut type) and then determining therefrom the representative for said groove type (or cut type), in particular by means of statistical methods. This has the advantage that the representative is geared more to the actual result of the machining operation and less to the grooving body, as described above, which means that the resemblance is potentially greater and the result is therefore more trustworthy. In addition to the groove type and the contour of the grooving body, in particular the parameters of grooving body spacing and/or web thickness are then taken into account, which are generally known and are, for example, part of the order data. As a result, these parameters are not subject to any uncertainty. In a suitable embodiment, the representative is simply determined as the mean value of the height profiles, i.e. the mean value as a function of the position along the height profile. It is advisable to eliminate any outliers beforehand, e.g. by ignoring those height profiles which deviate from the mean value by a certain (second) threshold value, e.g. 2σ, and then again calculating the mean value of the remaining height profiles and using it as a representative.

In a suitable development, the measured values of different positions are weighted differently when calculating the resemblance, e.g. with a weighting vector \vec{g}, which contains a weight for each position. The weighting vector is multiplied in particular element by element with the difference vector before the distance standard is formed. It is advisable to give greater weight to positions that show a lower statistical spread. The statistical spread as a function of the position is determined with the aid of the measured height profiles. For example, the statistical spread is simply a width of an envelope at a respective position of all height profiles or is the variance (i.e. the statistical parameter “variance”). In a particularly advantageous embodiment, the weight vector is determined by means of an exponential function as \vec{g}=e^{-\vec{b}}, wherein \vec{b} specifies the width of the envelope at the different positions.

The classification based on measured values also enables a continuous development of the representatives in the sense of training. In a suitable embodiment, the anomalies are each stored as a template and marked by storing for each template which cut and/or groove type this template belongs to. In this way, known assignments of anomalies to cut and/or groove type are created, which are particularly suitable as representatives, for creating representatives or as training data for training a learning machine (see below). The marking is effected, for example, by user input. The marked templates therefore contain correct assignments of anomalies to cut and/or groove types and are then advantageously used for the continuous updating of a respective representative, as described above.

Classification with a Learning Machine

In a third embodiment for classification, a learning machine is used which receives an anomaly (i.e. at least one or exactly one anomaly) as input parameter and then outputs the corresponding cut or groove type as output parameter. The learning machine is then part of the classification module. The learning machine is preferably a neural network with a plurality of neurons, which is assumed below without restriction of generality. In the previously described classification using modeling or based on measured values, the anomaly is essentially compared using a difference calculation and several representatives. By means of this comparison, the anomaly is assigned to a corresponding cut or groove type. When classifying with a learning machine, the anomaly is also assigned to a corresponding cut or groove type, but there is no direct comparison with representatives; rather, the corresponding information is encoded in the learning machine. Advantageously, the learning machine is appropriately trained for this purpose, specifically by means of supervised learning, i.e. the learning machine is trained with known assignments of anomalies to cut and/or groove type. The representatives already mentioned are also generally suitable for training.

A respective anomaly is used as input parameter for the learning machine. The input parameters form an input vector; the anomaly is preferably represented as a vector (which then contains in particular only the values but not the positions of the data points of the anomaly) and is used directly as an input vector. When classifying using a learning machine, it is advantageous to use both height profiles simultaneously as input parameters, i.e. not only to deliver an anomaly in the height profile on one side of the web to the learning machine but in addition also to deliver the corresponding section of the height profile (i.e. at the same machining positions) of the other side of the web, i.e. the opposite anomaly. Two such opposite anomalies form a pair of anomalies. This doubles the number of input parameters and the length of the input vector. This is particularly advantageous for classifying grooves.

The cut and/or groove types are also referred to as target classes in the context of the learning machine. In a suitable embodiment, the target classes are made accessible to the learning machine by one-hot (or equivalently one-cold) encoding. This means in particular that the cut and/or groove types typically named with a character string (e.g. “three-point groove”, “one-point groove” and “point-point groove”, “no groove (i.e. zero type)”) are now each designated with a vector which, depending on the cut and/or groove type, has a high bit at a single location and otherwise only low bits. The number of bits, i.e. the length of the vector, corresponds to the number of cut and/or groove types. Optionally, the already mentioned null type and/or other types also exist. The output parameters of the neural network form in particular an output vector with the same length.

The activation function for the individual neurons of the neural network is preferably the so-called rectified linear unit (ReLu) function, which is defined as relu(y):=max(y, 0). Since this ReLu function only returns a zero value over a certain range of values, individual neurons that are responsible for detecting a different cut or groove type in the input vector are effectively switched off. The classification result is therefore sharper. Moreover, the ReLu function is advantageously differentiable (with the exception of the coordinate origin).

The neural network generally has an input layer to receive the input vector and an output layer to output the output vector. The input layer and the output layer are connected via a number of hidden layers. In a suitable embodiment, the neural network has several, preferably three, hidden layers, with the number of neurons decreasing toward the output layer, preferably 300 in the first, 200 in the second and 100 neurons in the third hidden layer. Such an embodiment of the hidden layers has proven to be particularly advantageous. For example, a gradient descent method is chosen to train the neural network, and a statistical measure, preferably cross-entropy, is used as the cost function.

In a first advantageous embodiment, the learning machine is trained with correctly identified anomalies (e.g. based on the templates and/or representatives already mentioned above) and is then accordingly a learning machine trained with supervised training. The length of the output vector corresponds in particular to the number of cut and/or groove types plus any additional other types, so that the output vector then indicates how much the anomaly (or pair of anomalies, if both sides are entered simultaneously) delivered as input vector resembles a respective cut and/or groove type or other type.

In a second advantageous embodiment, the learning machine calculates the aforementioned respective representative of a groove type (or cut type), which is then used for classification as described above by comparing a respective anomaly with the representative. The representative is also referred to as the comparison signal. The learning machine thus generates a representative for each cut and/or groove type and is therefore used for modeling. Advantageously, the learning machine has been appropriately trained in advance. In a suitable embodiment, the learning machine already described is basically used inversely. For training, the learning machine receives in particular a groove type or cut type as input vector, e.g. correspondingly marked templates, in particular from previous measurements, and optionally further parameters such as corrugated cardboard thickness or grooving body spacing. The representative is then the output vector of the learning machine. The actual classification of an anomaly is then not carried out with said learning machine, but as already described above, possibly with a second learning machine. In other words, the learning machine calculates a representative, which separately from this calculation of the representative is compared with a measured height profile in order to determine its resemblance to the representative and thus also the resemblance of the groove type (or cut type) to the anomaly. In an advantageous embodiment, the learning machine calculates the representative as a function of the position, on the one hand, and additionally as a function of the grooving body distance.

Regardless of how classification is carried out in practice, the described optional detection of the zero type already makes it clear that classification can be used to basically detect and classify any characteristics of the web apart from cuts and grooves, especially damage to the web. Only corresponding representatives or marked measured values (i.e. correctly identified sections of the height profile) are used for this purpose, and classification is carried out as described. The same applies to the validation of the classification result described below.

Validation with the Validation Module

Advantageously, the previously described assignment and/or classification is additionally validated using the validation module. This means that the respective assignment of the anomalies at the detected machining positions to a cut and/or groove type is compared with the order data, specifically with the cuts and/or grooves predefined at the predefined machining position, and is in particular also evaluated. Validation is carried out in particular based on the one hand on the assignment of detected machining positions to predefined machining positions, which was carried out using the assignment module mentioned above, and based on the other hand on the classification of the anomalies, i.e. their assignment to specific cut and/or groove types.

Conveniently, the validation module is used to calculate the distances between a respective detected machining position and the assigned predefined machining position and then to determine a measure from all distances, e.g. the maximum or the mean value or the like, and to compare this measure with a further (third) threshold value. If the measure does not reach the threshold value, the assignment is considered valid (i.e. validated); otherwise, it is considered invalid, and the order is considered to be properly executed or faulty as regards the machining position. The validation module then in particular issues a corresponding message. Preferably, for each individual predefined machining position, it is output whether it is valid or not, i.e. whether it was carried out correctly or not.

Alternatively or additionally, the validation module is used in the same way to calculate the resemblance of a respectively detected cut and/or groove type to the cut and/or groove type required (i.e. predefined) in the order data at this machining position and then the resemblance is compared, preferably separately for each predefined machining position, with a further (fourth) threshold value. If the resemblance reaches the threshold value, the classification is considered valid; otherwise, it is considered invalid, and the order is considered to be properly executed or faulty as regards the cut and/or groove type. The validation module then issues a corresponding message. It is basically also advantageous to derive a single measure from the several similarities, e.g. the mean value, and to simply compare said mean value with the threshold value in order to easily validate the task as a whole.

In the event of discrepancies between the detected machining positions and/or the detected cut and/or groove types and the order data, a message is advantageously issued to an operator via an output element, e.g. as part of a human-machine interface (HMI), e.g. forwarded to a control station of the system. Preferably, such information pertaining to discrepancies is stored in a database with suitable metrics (time stamp, manifestation, etc.) for further analyses or pre-processors (machine learning, training for a learning machine, predictive and prescriptive analytics).

The system preferably includes an input element, e.g. likewise as part of the HMI, via which the issued messages, the measured height profiles and the results of position detection, assignment, classification and/or validation can be marked (also referred to as “labeling”) by an operator with additional information, e.g. metrics or identifiers, in particular “just-in-time”, in order to supplement relevant information about production, process and product quality or to make it available in the first place and specifically to generate the templates mentioned above. This information is preferably stored in a database and used for further evaluations and learning processes, e.g. for the above-described training of the learning machine.

The information mentioned is also suitable for forwarding to one or more higher-level systems in order to be used even outside the operation of the system and the machining of the web, e.g. for production planning or the generation or adjustment of order data.

The database mentioned is, for example, implemented as a cloud solution, namely separately from the system, or as part thereof and thus as an on-premises solution. The method itself and in particular the computer program product are advantageously executed on the system itself. Alternatively or additionally, the method itself and in particular the computer program product are implemented as a cloud solution to which the system is connected.

The computer program product according to the invention comprises commands which, when executed by a computer, cause the computer to partially or fully execute in particular the method described above. In a suitable embodiment, the commands, when executed by a computer, cause the computer to identify a number of anomalies in a measured height profile of a web by identifying such portions of the height profile where the height profile reaches a predefined threshold value as an anomaly and to then classify a respective anomaly by assigning this to a cut type or groove type (i.e. one of several cut and/or groove types) which the anomaly most closely resembles.

In the following, exemplary embodiments of the invention are explained in more detail with reference to a drawing. In the drawing:

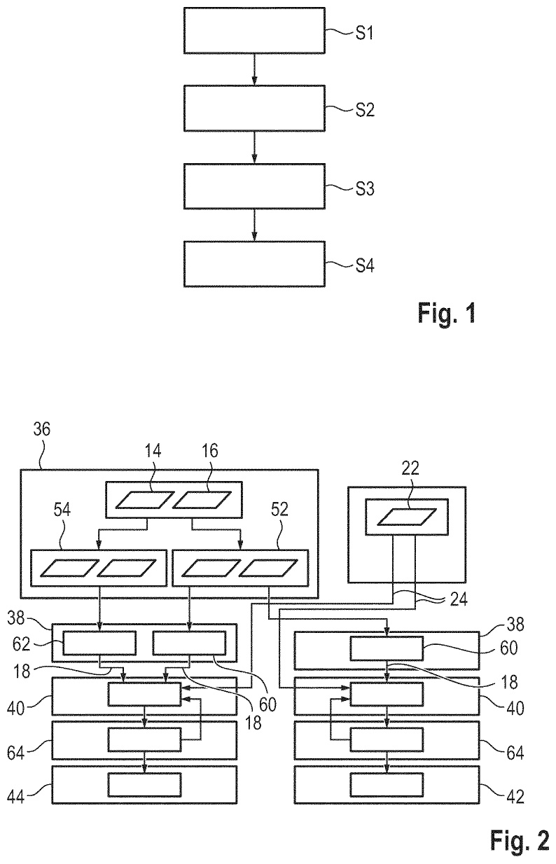

FIG. 1 shows a method,

FIG. 2 shows a process diagram,

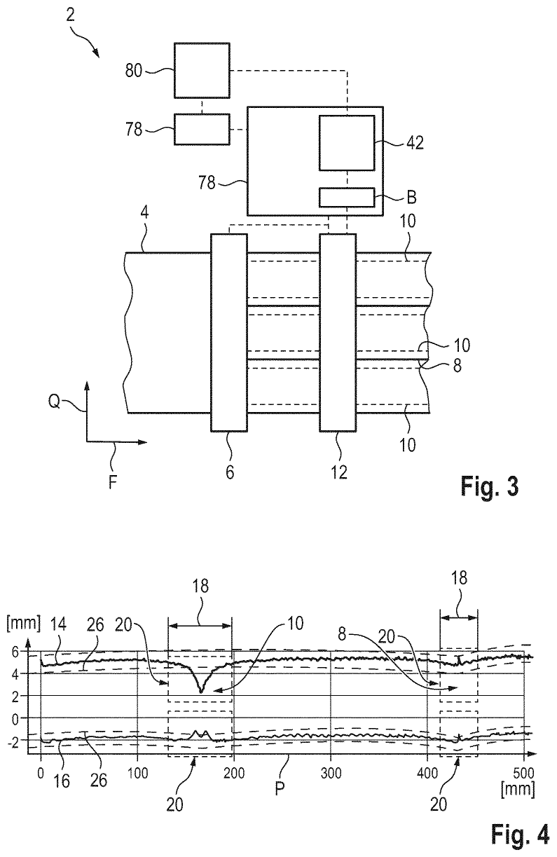

FIG. 3 shows a system,

FIG. 4 shows two height profiles in section,

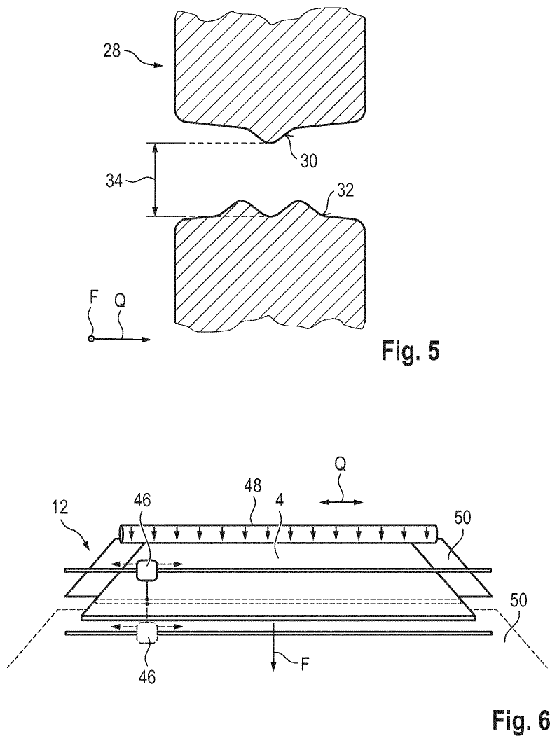

FIG. 5 shows a grooving body in a cross-sectional view,

FIG. 6 shows two aspects of a sensor unit from FIG. 3,

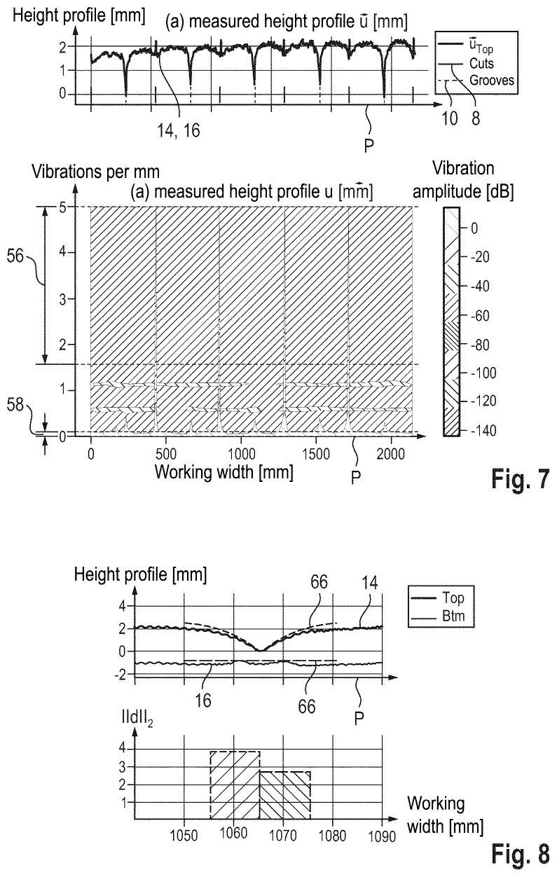

FIG. 7 shows a height profile and its spectrogram,

FIGS. 8 to 10 each show a comparison of two height profiles with one representative each,

FIG. 11 shows a plurality of height profiles for the same groove type,

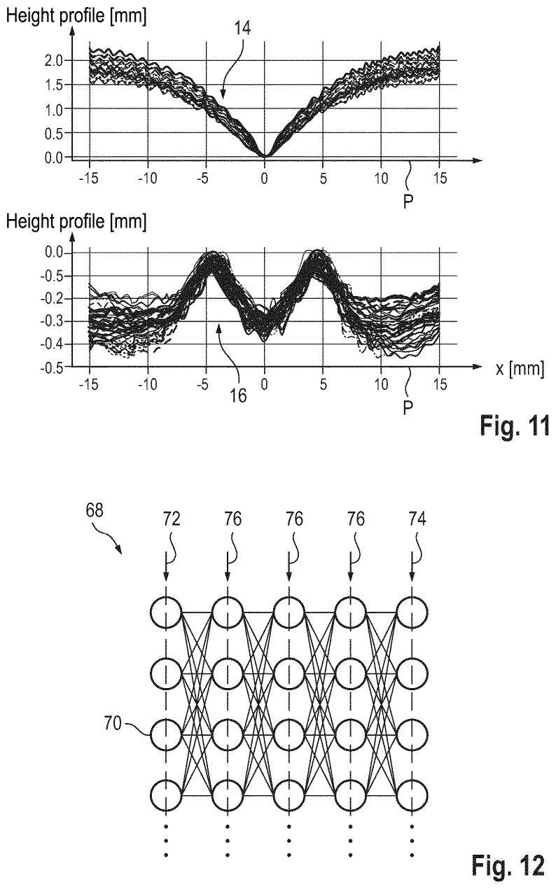

FIG. 12 shows a learning machine,

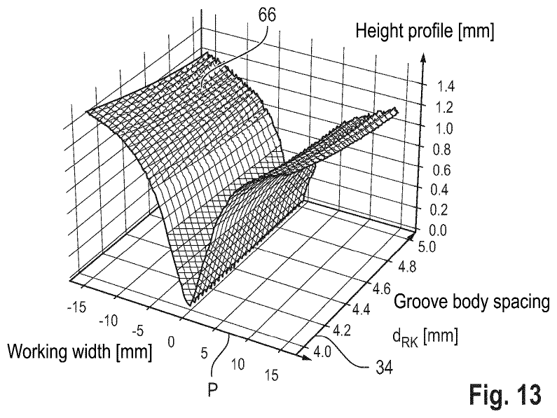

FIG. 13 shows a representative.

FIG. 1 shows an exemplary embodiment of a method according to the invention. FIG. 2 then shows a process diagram with further details of the method. FIG. 3 shows an exemplary system 2 in which the method is implemented. First, in a first step S1, a web 4 is provided in which a number of machining operations 8, 10 have been made by means of a cutting/grooving unit 6 of the system 2, in each case on the basis of a predefined cut type or groove type. Here and in general, “a number of” is understood to mean “one or more” or “at least one.” The machining operations 8, 10 are mechanical operations on the web 4 and in the present case are either a cut 8 or a groove 10 in the web 4. Each cut 8 was made according to a predefined cut type and each groove 10 according to a predefined groove type. The cuts 8 and grooves 10 are used for cutting the web 4 into single panels or sheets and for forming breaking, folding or creasing edges of the panels or of the subsequent sheets, e.g. in order to form each of these into a box, carton or the like.

In the exemplary embodiment shown, the web 4 is both cut and grooved using the cutting/grooving unit 6. In the present case, the system 2 is a corrugated cardboard system for producing corrugated cardboard, specifically sheets of corrugated cardboard. The web 4 is made of paper and is a corrugated cardboard web composed of several layers of paper. As can be seen in FIG. 3, a height profile 14, 16 of the web 4 is measured in-line downstream of the cutting/grooving unit 6 using a sensor unit 12, more precisely two height profiles 14, 16, namely an upper height profile 14 on a top side of the web 4 and a lower height profile 16 on a bottom side of the web 4.

The web 4 is machined by means of the cutting/grooving unit 6 at a number of machining positions 18 (i.e. cutting and/or grooving positions). Due to the principles involved, an anomaly 20 is formed at each actual machining position 18. These actual machining positions 18 are detected together with the anomalies 20 and are then also referred to as detected machining positions 18. The machining positions are predefined by order data 22 for an order for the system 2. Accordingly, the order data 22 then contains predefined machining positions 24. The cut type or groove type to be implemented at each machining position 24 is also predefined in the order data 22, so that a predefined cut type or groove type is also assigned to each predefined machining position 24 in the order data 22. The cutting/grooving unit 6 is controlled according to the order data 22. However, due to errors or inaccuracies, the cutting/grooving unit 6 does not necessarily produce the machining operations 8, 10 in such a way that the predefined machining positions 24 match the actual machining positions 18, and the required cut or groove type may not be reproduced exactly, or even an incorrect cut or groove type may be used.

In the method described herein, in a second step S2 a height profile 14, 16 is measured on both sides of the web 4 using the sensor unit 12 and transversely to a conveying direction F of the web 4. An example of such height profiles 14, 16 is shown in FIG. 4, in which two anomalies 20 can be seen at each of two actual machining positions 18, i.e. a total of two pairs of anomalies, one pair of which belongs to a cut 8 and the other pair to a groove 10, more precisely to a three-point groove. Further height profiles 14, 16 are also shown in FIGS. 7 to 10.

As can be seen in FIG. 4, the machining operations 8, 10 carried out by the cutting/grooving unit 6 can be seen as anomalies 20 in the respective height profile 14, 16, i.e. as deviations from a normal state of the web. In a third step S3, the anomalies 20 in the height profiles 14, 16 are now identified by identifying as an anomaly 20 those sections of the height profiles 14, 16 in which the respective height profile 14, 16 reaches, exceeds or falls below, a predefined (first) threshold value 26, i.e. depending on the observation. As indicated by the dashed frames in FIG. 4, the section is not only the region in which the height profile 14, 16 actually reaches the threshold value 26 but which contains a certain addition to both sides.

In FIG. 4, reaching the threshold value 26 is particularly clear for the groove 10. The cut 8, on the other hand, is not necessarily detected as shown, but can also be identified in other ways, as will be described below.

In a fourth step S4, a respective anomaly 20 is then classified by assigning it to the cut and/or groove type which this anomaly 20 most closely resembles. Therefore not only is it checked whether or to what extent a particular machining operation 8, 10 corresponds to the cut or groove type according to the order data 22, but it is also checked which cut or groove type is actually present (if necessary with specification of a confidence value for this). This classification differs from a simple target/actual comparison in that the anomaly 20 is not only compared with a single cut or groove type, but with several different ones. In addition, by using the threshold value 26, anomalies 20 are actively searched for in the entire height profile 14, 16 rather than only checking the height profile 14, 16 at the predefined machining positions 24.

The cutting/grooving unit 6 has one or more corresponding cutting bodies and/or grooving bodies 28 for cutting and/or grooving. In both cases, the web 4 is mechanically machined; in the case of cutting, it is merely separated, and in the case of grooving, it is reshaped. A cutting body typically has at least one blade, which is inserted into the web 4 in order to produce a cut 8. Analogously, a grooving body 28 regularly has two profiled running surfaces 30, 32, which are arranged on opposite sides of the web 4 and interact. An example of a grooving body 28 for a three-point groove is shown in FIG. 5. A so-called offset groove is also possible when the running surfaces 30, 32 of a grooving body 28 is displaced in the transverse direction Q. This displacement is referred to as an offset. A further displacement perpendicular to both the transverse direction Q and the conveying direction F is also regularly possible in order to adjust the so-called grooving body distance 34.

Various aspects and embodiments of the method are described in detail below; reference is made specifically to FIG. 2. In order to evaluate a height profile 14, 16 and to detect anomalies 20 therein, the height profile 14, 16 is first processed and filtered within the scope of pre-processing 36, which in this case uses methods of digital signal processing. Subsequently, detected machining positions 18 are identified in the height profile 14, 16 by means of a position detection 38, which in the present case applies statistical methods; accordingly, the anomalies 20 are also identified in this process. The detected machining positions 18 are then assigned 40 to the predefined machining positions 24 from the order data 22. Position detection 38 and assignment 40 are carried out separately in FIG. 2, namely once for cuts 8 and once for grooves 10; a division of the anomalies 20 into two corresponding groups has been carried out already during pre-processing 36.

For further analysis, the method described herein uses the already mentioned classification operation 42, by means of which the height profile 14, 16 is classified portion by portion at the detected machining positions 18 with regard to the machining operations 8, 10 carried out, i.e. the anomalies 20 are classified. In the exemplary embodiment in FIG. 2, only the grooves 10 are classified; a classification of the cuts 8 is not carried out, but is optionally also implemented. In the present case, the cuts 8, or more precisely their machining positions 18, are only validated by validation 44. Optionally, a validation of the result of classification 42 is carried out, although this is not explicitly shown in FIG. 2, but is possible analogously to the validation 44 already mentioned. During validation 44 of the machining positions 18, a message is issued, the system 2 is stopped or another suitable measure is initiated as soon as it is determined that the detected machining positions 18 do not correspond within a given tolerance with the predefined machining positions 24 from the order data 22. Validation of the result of classification 42 with the aid of the order data 22 is carried out analogously to the validation 44 of the machining positions 18, i.e. it is checked whether the correct cut or groove type has been applied and/or carried out correctly, and whether the cuts 8 and grooves 10 were made with the correct cutting or grooving body 28. As soon as it is determined during this validation that the detected machining operations 8, 10 do not match the predefined cut and/or groove types from the order data 22 within a given tolerance, a corresponding message is issued, the system 2 is stopped or another suitable measure is initiated.

### Measurement (First Step S1)

The height profile 14, 16 is measured, for example, using a sensor unit 12 as shown in FIG. 6. In FIG. 6, the sensor unit 12 is shown on the left as viewed in the conveying direction F and on the right as viewed in the transverse direction Q perpendicular to the conveying direction F. The sensor unit 12 has two sensors 46, namely, in the present case, distance sensors, specifically laser triangulation sensors, which can be offset transversely to the web 4 and measure a distance in the direction of (i.e. toward) the web 4, i.e. the distance between sensor 46 and web 4. The sensor 46 outputs a measured value (distance) for each measuring position across the web 4, which measured value varies depending on the nature of the surface of the web 4. As a result, each sensor 46 outputs a height profile 14, 16 which contains a series of measured values. Each measured value is also assigned a position P (measurement position) along web 4. A measured value together with the corresponding position P forms a data point. In the present case, the sensor unit 12 is arranged directly downstream of the cutting/grooving unit 6. In addition, the sensor unit 12 shown herein has a pressure roller 48 in order to press the web 4 against a support 50 as it passes through the sensor unit 12 and when measuring the height profile 14, 16, and to suppress any curvature of the web 4 as far as possible, at least during the measurement.

### Pre-Processing (Second Step S2)

During pre-processing 36, the measured height profile 14, 16 is processed in a suitable manner for subsequent position detection 38. For example, it is possible that the measuring range is exceeded when measuring the height profile 14, 16 and no distance can be measured, which is regularly the case with a cut 8 because the web 4 is severed at the cut's machining position 18. Accordingly, if the measuring range is exceeded, it may not be possible to generate a valid measured value; instead, a NaN (not a number) is returned as the measured value and a corresponding gap is found at the corresponding position P in the height profile 14, 16. Now, during pre-processing 36, such gaps in the height profile 14, 16 are specifically removed in a block 52 in order to obtain a gap-free height profile 14, 16. However, the gaps are not simply omitted but are replaced by suitable values. In addition, in the block 52 the height profile 14, 16 is mapped onto an equidistant grid. New data points with new (measured) values and new positions P are generated from the measured values and measuring positions, which are distributed along an equidistant grid.

The pre-processing 36 in FIG. 2 further comprises a further block 54 in which the gaps and their positions P are identified.

The anomalies 20 are also visible in the frequency domain, specifically in the spectrogram of the height profile 14, 16. An exemplary spectrogram is shown in the lower part of FIG. 7, while the upper part shows the corresponding height profile 14, 16. In FIG. 7, the data point density of the height profile 14, 16 is, for example, ten data points per millimeter, as a result of which the spectrogram can be represented in a frequency range from 0 to 5 mm⁻¹ (in the vertical direction). As shown in FIG. 7, continuous lines appear in the spectrogram at exactly the same positions P as actually performed cuts 8 (parallel to the vertical frequency axis). This means that a cut 8 can be identified across the entire frequency spectrum and that by filtering out a suitable sub-range from the frequency spectrum (i.e. by selecting a specific frequency range 56) in which only the frequencies of a cut 8 are contained, the influence of this cut 8 on the measured height profile 14, 16 can be represented in isolation and thus makes possible an identification of the cut 8. In one possible embodiment, a corresponding frequency range 56 is therefore released with the aid of a bandpass filter B. In FIG. 7, a suitable frequency range 56 is, for example, from 1.5 mm⁻¹ up to, in particular, 5 mm⁻¹, since in this frequency range 56 only the effect of the cuts 8 is visible in the spectrogram and all other influences on the height profile 14, 16 lie completely or at least predominantly below this frequency range 56. Accordingly, the upper limit is not necessarily important; rather, it is defined by the data point density. Similarly, at the machining positions 18 of grooves 10, anomalies in the frequency range 58 from 0 mm⁻¹ up to about 0.1 mm⁻¹ are recognizable in the spectrogram, so that in a possible embodiment a corresponding frequency range 58 is released with the aid of a bandpass filter B. In FIG. 7, a suitable frequency range 58 ranges from 0.001 mm⁻¹ (to suppress the DC component in the height profile 14, 16 at 0 mm⁻¹) up to 0.1 mm⁻¹.

### Position Detection (Third Step S3)

In the present case, the threshold value 26 is a standard deviation of the respective height profile 14, 16. The standard deviation forms a threshold value 26, which depends on the position P and forms an envelope (cf. FIG. 4) around the height profile 14, 16. If the height profile 14, 16 breaks through said envelope, i.e. reaches the threshold value 26, this means that there is an anomaly 20 at this position P, which is also identified as such. In FIG. 2, this identification of an anomaly 20 by reaching the threshold value 26 takes place in the block 60. The threshold value 26 and specifically its determination benefit from the above-described filtering of the height profile 14, 16 with the aid of a bandpass, as this limits the height profile 14, 16 to the anomaly 20 sought (cuts 8 or grooves 16) and facilitates its identification by means of statistical methods. The positions P of the identified anomalies 20 of the height profile 14, 16 are also considered as candidates for detected machining positions 18 in order to be subsequently assigned to a predefined machining position 24 by means of the assignment 40.

In order to detect cuts 8, in the block 60 anomalies 20 are identified separately in both height profiles 14, 16, and an anomaly 20 is then identified as a cut 8 at a machining position 18 if an anomaly 20 has been identified at this machining position 18 in both the upper and lower height profiles 14, 16. In addition, in the block 62 (detection based on a gap), an anomaly 20 at a machining position 18 is identified as a cut 8 if there is a gap in the upper or lower height profile 14, 16 at this machining position 18. For this purpose, the positions P identified there with gaps are transferred from the block 54 to the block 62. The above criteria are linked so that the presence of one of the criteria is sufficient for detecting a cut 8.

In order to detect grooves 10, a differential height profile is calculated from the lower and upper height profiles 14, 16 and is then filtered with a bandpass filter B as described above. If the differential height profile reaches the threshold value 26 at a machining position 18 during identification in the block 60, a groove 10 will be detected at this machining position 18.

By means of the two aforementioned steps for detecting cuts 8 on the one hand and for detecting grooves 10 on the other hand, the identified anomalies 20 are divided into two groups even before classification 42, namely into a first group containing all anomalies 20 that were generally detected as cuts 8 (on the left in FIG. 2), and into a second group that analogously contains all anomalies 20 that were detected as grooves 10 (on the right in FIG. 2). The anomalies 20 are thus pre-sorted. In FIG. 2, only the group of anomalies 20 that were identified as grooves 10 is classified in order to assign a specific groove type to each of these anomalies 20.

### Assignment of Machining Positions

Each anomaly 20 is assigned an actual machining position 18, which is detected by identifying the anomaly 20 and is then also referred to as a detected machining position 18. During assignment 40, the actual machining positions 18 are assigned to the predefined machining positions 24 and are compared for this purpose. For this purpose, a correlation table is generated, for example, which contains the resemblance of each actual machining position 18 to each predefined machining position 24. For example, the correlation table is a simple distance table that contains the distances of each actual machining position 18 from each predefined machining position 24. The respective actual machining position 18 is then assigned the predefined machining position 24 which most closely resembles the actual machining position 18, i.e. has the greatest resemblance to the actual machining position 18, e.g. has the smallest distance from the actual machining position 18. This prevents double assignment, so that each actual machining position 18 is assigned at most one predefined machining position 24, and vice versa.

By means of the comparison, any superfluous machining positions are also detected, i.e. those machining positions 18 which have been detected but cannot be assigned to a predefined machining position 24 in the order data 22. They can also include for example anomalies 20 that were not generated by the cutting/grooving unit 6. Conversely, missing predefined machining positions 24 are detected analogously. In FIG. 2, for this purpose specifically the block 64 is used which generates feedback on the assignment 40 in order to adjust one or more parameters (e.g. the threshold value 26, limit value (see below), search area in the height profile 14, 16), if necessary, for the identification of the anomalies 20. Moreover, in the present case, a limit value for resemblance is defined during assignment 40, which must at least be reached in order to carry out an assignment. If distance is used as a measure of resemblance, the limit value is accordingly a maximum distance (e.g. 5 mm). In this way, a forced assignment is avoided.

### Classification (Fourth Step S4)

The detected machining positions 18, which have been optionally assigned to predefined machining positions 24 as described, are now classified and thus each assigned to one of several cut types or groove types. Since typically several different grooving bodies 28 are used, different grooves 10 and thus, depending on the order, also different anomalies 20 are generated accordingly (analogously for cuts 8). Each grooving body 28 has its own characteristic, which leads to a corresponding characteristic of the anomaly 20 created. A cut 8 usually has a much simpler characteristic than a groove 10. Since a cut 8 is essentially a severance of the web 4 at a specific machining position 18, it is initially sufficient to simply search for such a severance (e.g. by means of gaps in the measured values). As can be seen in FIG. 2, validation with the order data 22 is therefore generally possible for cuts 8 even without classification. It is basically also possible in principle to distinguish between cuts 8 and grooves 10 without classification 42. Accordingly, in the exemplary embodiment shown herein, cuts 8 are first distinguished from grooves 10 and then only those anomalies 20 are classified at the machining positions 18 at which grooves 10 were detected. For this reason, the classification 42 of grooves 10 is primarily described below. However, the explanations apply analogously to cuts 10.

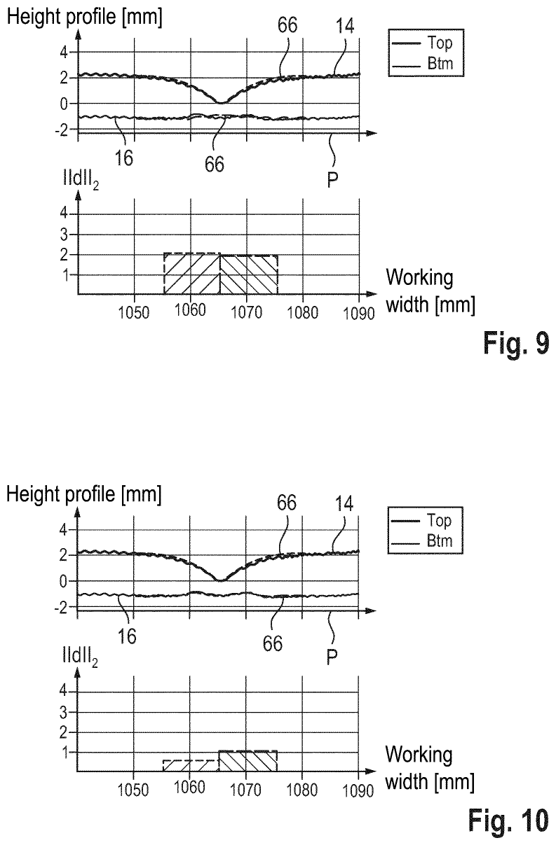

In one possible embodiment, a respective anomaly 20 is compared for purposes of classification 42 with a representative 66 of a respective groove type and the resemblance (i.e. agreement) of the anomaly 20 and the groove type is calculated by means of a distance standard. This is shown as an example in FIGS. 8, 9 and 10, which in each case show in the upper part a comparison of two height profiles 14, 16 each with three different representatives 66 (i.e. a total of six representatives 66), wherein two representatives 66 always form a pair and are assigned to a specific groove type. The height profiles 14, 16 are the same in all three FIGS. 8, 9 and 10. The groove types shown are: a point-flat groove in FIG. 8, a point-point groove in FIG. 9 and a three-point groove in FIG. 10. In the lower part, the pairs of results of the comparisons are shown as two bars, namely three comparisons each of the upper and lower height profile 14, 16 with a corresponding representative 66. In the process, a difference was formed from the data points of the respective anomaly 20 and of the respective representative 66 at a respective position P (i.e. component by component in case of a vector) and these differences are then summed for each of the two height profiles 14, 16. The two sums, one for the upper and one for the lower height profile 14, 16, are then shown as bars. When comparing the three pairs of bars, it becomes clear that in the case of the three-point profile in FIG. 10 the lowest total sum (sum of both sums of the differences) is achieved overall, i.e. there is the greatest resemblance. Both anomalies 20 (i.e. the pair of anomalies) are therefore assigned to the three-point groove type.

Classification with Modeling

In one possible embodiment for the classification 42, the representatives 66 are determined by means of a physical model that simulates the generation of grooves 10 on the basis of a geometry of a respective grooving body 28. First, a reference model is created for each groove type on the basis of the associated grooving body 28, which reference model contains all relevant properties of the corresponding groove 10. The reference model then serves as representative 66 for classification 42. Each anomaly 20 is then compared with different representatives 66 and classified (see FIGS. 8, 9 and 10) as the groove type whose representative 66 most closely resembles the anomaly 20. In one possible embodiment, the representative 66 is generated from design data of the grooving body 28, e.g. by directly using as representative 66 its contour in the transverse direction Q, as shown in FIG. 5.

### Classification Based on Measured Values

In another possible embodiment for the classification 42, the representative 66 of a respective groove type is determined on the basis of previous measured values, e.g. by recording a plurality of height profiles 14, 16 for a respective groove type, e.g. as shown in FIG. 11, and then determining therefrom the representative 66 for this groove type, e.g. simply as the mean value of the height profiles 14, 16. Optionally, any outliers are eliminated beforehand, e.g. by ignoring those height profiles 14, 16 which deviate from the mean value by a certain threshold value, and then again calculating the mean value of the remaining height profiles 14, 16 and using it as representative 66. Likewise optionally, the measured values of different positions P are weighted differently when calculating the resemblance before the distance standard is formed as described above. In particular, those positions P having a lower statistical spread are given greater weight; in FIG. 11 these are mainly the positions P at which the upper height profile 14 assumes a minimum and the lower height profile 16 a maximum (in FIG. 11 two maxima).

Classification with a Learning Machine

In a further possible embodiment for the classification 42, a learning machine 68 is used, which receives an anomaly 20 as input parameter and then outputs the associated groove type as output parameter. An exemplary embodiment of the learning machine 68 is shown in FIG. 12, in which the learning machine 68 is a neural network with a plurality of neurons 70. In the present case, the learning machine 68 is trained by means of supervised training.

A respective anomaly 20 is used as input parameter for the learning machine 68, i.e. a section of the height profile 14, 16. The input parameters form an input vector. In the present case, even both height profiles 14, 16 are used simultaneously, i.e. not only an anomaly 20 in the height profile 14, 16 on one side of the web 4, but also the opposite anomaly 20. This doubles the number of input parameters and the length of the input vector. The cut and/or groove types are made accessible to the learning machine 68 by one-hot coding. The output parameters of the neural network then form an output vector with a length corresponding to the number of groove types. For example, the ReLu function is used as the activation function for the individual neurons of the neural network. The neural network generally has an input layer 72 for receiving the input vector and an output layer 74 for outputting the output vector. The input layer 72 and the output layer 74 are connected via a number of, in this case three, hidden layers 76, e.g. with the number of neurons 70 decreasing toward the output layer 74. The learning machine 68 is, for example, trained with correctly identified anomalies 20 and is then correspondingly a learning machine 68 trained through supervised training.

An embodiment is also possible in which the learning machine 68 calculates the aforementioned respective representative 66 of a groove type, which is then used for classification 40 as described above by comparing a respective anomaly 20 with the representative 66. The learning machine 68 thus generates a representative 66 for each groove type and is thus used for modeling. In FIG. 13, a representative 66 calculated in this way is shown, which is a function of the position P on the one hand and additionally a function of the grooving body distance 34.

### Validation

Validation 44 is on the one hand based on the assignment 40 of detected machining positions to predefined machining positions 18, 24, which was carried out as further described (in FIG. 2 shown for the cut types) or on the other hand based on the classification 42 of the anomalies 20, i.e. their assignment to specific cut and/or groove types (not explicitly shown in FIG. 2).

During validation 44 as shown in FIG. 2, the distances between a respective detected machining position 18 and the assigned predefined machining position 24 are calculated and then a measure is determined from all distances, e.g. the maximum or the mean value or the like, and this measure is compared with a threshold value. If the measure does not reach the threshold value, the assignment 40 will be considered valid (i.e. validated); otherwise, it will be considered invalid, and the order considered to be properly executed or faulty as regards the machining position 18, 24.

Alternatively or additionally, the resemblance of a respectively detected cut and/or groove type to the cut and/or groove type required (i.e. the predefined type) in the order data 22 at this machining position 18 is calculated analogously and then the resemblance for each predefined machining position 24 is compared separately with a threshold value. If the resemblance reaches the threshold value, the classification 42 will be considered valid; otherwise, it will be considered invalid, and the order considered to be properly executed or faulty as regards the cut and/or groove type.

In the event of discrepancies between the order data 22 and the detected machining positions 24 and/or the detected cut and groove types, a message is issued to an operator via an output element, e.g. as part of a human-machine interface 78, e.g. forwarded to a control station of the system 2. The system 2 shown herein also includes, as part of the human-machine interface 78, an input element (not explicitly shown), via which the issued messages, the measured height profiles 14, 16 and the results of position detection 36, assignment 40, classification 42 and/or validation 44 can be marked by an operator with additional information, e.g. metrics or identifiers, in particular “just-in-time,” in order to supplement relevant information about production, process and product quality or to make it available in the first place and specifically to generate the templates mentioned above. This information is stored in a database 80 and used for further evaluations and learning processes.

The system 2 further comprises a control unit 82 which is designed to carry out the method as described.

### LIST OF REFERENCE SIGNS

2 System
4 Web
6 Cutting/grooving unit
8 Machining, cut
10 Machining, groove
12 Sensor unit
14 Upper height profile
16 Lower height profile
18 Actual/detected machining position
20 Anomaly
22 Order data
24 Predefined machining positions
26 (First) threshold value
28 Grooving body
30 Profiled running surface
32 Profiled running surface
34 Grooving body distance
36 Pre-processing
38 Position detection
40 Assignment (of machining positions)
42 Classification
44 Validation
46 Sensor
48 Pressure roller
50 Support
52 Block (of pre-processing)
54 Further block (of pre-processing)
56 Frequency range (for cuts)
58 Frequency range (for grooves)
60 Block (identification of an anomaly by reaching the threshold value)
62 Block (detection based on a gap)
64 Block
66 Representative
68 Learning machine
70 Neuron
72 Input layer
74 Output layer
76 Hidden layer
78 Human-machine interface
80 Database
82 Control unit
B Bandpass filter
F Conveying direction
P Position
Q Transverse direction
S1 First step (measurement)
S2 Second step (pre-processing)
S3 Third step
S4 Fourth step

1. A method,
wherein a web is provided in which a number of machining operations have been made by means of a cutting/grooving unit, in each case on the basis of a height machining position and a predefined cut type or groove type,
wherein a height profile of the web is measured using a sensor unit on at least one side of the web and transversely to a conveying direction of the web,
wherein a number of anomalies and thus also actual machining positions are identified in the height profile by identifying as an anomaly such sections of the height profile where the height profile reaches a predefined threshold value,
wherein a respective anomaly is classified by means of classification by assigning the anomaly to the cut type or groove type which the anomaly most closely resembles.

2. The method according to claim 1,
wherein, for classification, a learning machine is used, which receives an anomaly as input parameter and then outputs the associated cut or groove type as output parameter.

3. The method according to claim 1,
wherein a learning machine is used to calculate a respective representative of a groove type or cut type, which is then used for classification by a respective anomaly being compared with the representative.

4. The method according to claim 2,
wherein the learning machine is a neural network with a plurality of neurons,
wherein the ReLu function is used as the activation function for the individual neurons,
wherein the neural network has an input layer and an output layer,
wherein the neural network has several hidden layers, with the number of neurons decreasing toward the output layer.

5. The method according to claim 1,
wherein a respective anomaly is compared for purposes of classification with a representative of a respective cut or groove type and the resemblance of the anomaly and the cut or groove type is calculated using a distance standard,
wherein the representative of a respective cut or groove type is determined on the basis of previous measured values by recording a plurality of height profiles for a respective cut or groove type and then determining therefrom the representative for this cut type or groove type.

6. The method according to claim 1,
wherein a respective anomaly is compared for purposes of classification with a representative of a respective cut or groove type and the resemblance of the anomaly and the cut or groove type is calculated using a distance standard,
wherein the representatives are determined by means of a physical model that simulates the generation of grooves and/or cuts on the basis of a geometry of a respective grooving body or cutting body of the cutting/grooving unit.

7. The method according to claim 1,
wherein the resemblance of a respectively detected cut and/or groove type to the respectively predefined cut and/or groove type is calculated and then the resemblance for each predefined machining position is compared separately with a further threshold value,
wherein the classification is considered valid if the resemblance reaches the threshold value; otherwise, it is considered invalid.

8. The method according to claim 1,
wherein a respective actual machining position is assigned the predefined machining position which most closely resembles the actual machining position.

9. The method according to claim 8,
wherein a limit value for resemblance is defined which must at least be reached in order to carry out an assignment in order to prevent a forced assignment.

10. The method according to claim 8,
wherein distances between a respective actual machining position and the assigned predefined machining position are calculated,
wherein a measure is determined from all distances, which measure is compared with a further threshold value,
wherein the assignment is considered valid if the measure does not reach this further threshold value; otherwise, it is considered invalid.

11. The method according to claim 1,
wherein the height profile is filtered with a bandpass filter (B) before the anomalies are identified therein,
wherein the bandpass filter releases a frequency range-which is selected such that those parts of the height profile-which are generated either by cuts or by grooves are specifically retained.

12. The method according to claim 1,
wherein the threshold value is a standard deviation of the height profile.

13. The method according to claim 1,
wherein anomalies are identified separately in an upper height profile on a top side of the web and in a lower height profile on a bottom side of the web,
wherein an anomaly is identified as a cut at a machining position if an anomaly has been identified at this machining position in both the upper and lower height profile, and/or
wherein an anomaly is identified as a cut at a machining position if there is a gap in the upper or lower height profile at said machining position.

14. The method according to claim 1,
wherein a differential height profile is calculated from an upper height profile on a top side of the web and a lower height profile on a bottom side of the web,
wherein, if the differential height profile reaches the threshold value at a machining position, an anomaly is identified at said machining position.

15. The method according to claim 1,
wherein the cutting/grooving unit and the sensor unit are part of a corrugated cardboard system and wherein the web is a corrugated cardboard web which is produced and processed by the corrugated cardboard system,
wherein the height profile is measured inline in the corrugated cardboard system and downstream of the cutting/grooving unit.

16. A system having a control unit designed to carry out a method according to claim 1.

17. A computer program product comprising commands which, when executed by a computer, cause the computer to
identify a number of anomalies and thus also actual machining positions in a measured height profile of a web by identifying as an anomaly such portions of the height profile where the height profile reaches a predefined threshold value,
classify a respective anomaly by means of classification by assigning the anomaly to a cut type and/or groove type which this anomaly most closely resembles.
